(19) United States
(12) Patent Application Publication
(10) Pub. No.: US 2021/0256456 A1
(43) Pub. Date: Aug. 19, 2021

(54) WORK LOG POSTING SYSTEM

(71) Applicant: Tamkang University, New Taipei City (TW)

(72) Inventors: Chih-Yung Chang, New Taipei City (TW); Shih-Jung Wu, New Taipei City (TW); Kuo-Chung Yu, New Taipei City (TW); Li-Pang Lu, New Taipei City (TW); Chia-Chun Wu, New Taipei City (TW)

(73) Assignee: Tamkang University, New Taipei City (TW)

(21) Appl. No.: 16/912,159

(22) Filed: Jun. 25, 2020

(30) Foreign Application Priority Data
Feb. 15, 2020 (TW) 109104894

(51) Int. Cl. G06Q 10/06; G06Q 10/10; G06F 3/0488

(52) U.S. Cl. CPC G06Q 10/063114; G06F 3/0488; G06Q 10/06313; G06Q 10/1091

(57) ABSTRACT

A work log posting system includes a project database, a meeting record analysis module, a project classification module, and a work log module. The project database stores a plurality of keyword sets, each corresponding to a project. The meeting record analysis module analyzes a meeting record including a statement content, an attendance list, and a meeting period, to extract a plurality of terms from the statement content of the meeting record. The project classification module classifies the meeting record to one of the projects according to the relevance between the terms in the statement content and each keyword set. The work log module counts, according to the classification result of the meeting record, the meeting period attended by each person on the attendance list and the project to which the meeting period belongs, so as to preload the statistical result into a work log.

### CROSS-REFERENCE TO RELATED APPLICATION

This non-provisional application claims priority under 35 U.S.C. § 119(a) to Patent Application No. 109104894 in Taiwan, R.O.C. on Feb. 15, 2020, the entire contents of which are hereby incorporated by reference.

### BACKGROUND

### Technical Field

This application relates to a posting system, especially a work log posting system.

### Related Art

When a project is in progress, members of a project team generally have a lot of work to discuss. Nowadays, types of meetings in many companies have changed from face-to-face meetings to online discussion meetings, for example, project meetings held in messaging and chat software (such as Line). Therefore, in order to monitor project progress and enable each employee to have good time management and performance management, a company generally require each employee to write a daily work log, so that the employee can understand content of the daily work, the time spent on the work, and the progress. The work log is also a basis for the manager to inspect the work performance and the project progress of the employee. However, due to busy work, when an employee fills in a daily work log, he/she often needs to spend time and energy to recall work content of the whole day and tends to forget odds and ends, resulting in omission of the content of the work log.

### SUMMARY

In view of the above, this application provides a work log posting system, which can automatically record a project meeting period in a work log and assist a user in posting the work log.

According to some embodiments, the work log posting system includes a project database, a meeting record analysis module, a project classification module, and a work log module. The project database stores a plurality of keyword sets, each corresponding to a project. The meeting record analysis module analyzes a meeting record including a statement content, an attendance list, and a meeting period, to extract a plurality of terms from the statement content of the meeting record. The project classification module classifies the meeting record to one of the projects according to the relevance between the terms in the statement content and each keyword set. The work log module counts, according to the classification result of the meeting record, the meeting period attended by each person on the attendance list and the project to which the meeting period belongs, so as to preload the statistical result into a work log.

According to some embodiments, the meeting record analysis module analyzes the meeting record to calculate a term frequency of each sentence in the statement content, and extracts the terms in the sentences from the statement content according to the term frequencies.

According to some embodiments, the meeting record analysis module analyzes the meeting record and the keyword sets to extract the terms appearing in the keyword sets from the statement content.

According to some embodiments, the project classification module calculates the relevance according to a term frequency corresponding to each term in the statement content and a keyword set frequency corresponding to each keyword set in each project.

According to some embodiments, the work log posting system further includes a project classification training module. The project classification training module performs a training operation according to a plurality of files of the projects and generates a determination logic to predict the relevance between the terms in the statement content and each keyword set. The project classification module classifies the meeting record to one of the projects according to the determination logic.

According to some embodiments, the work log posting system further includes a project classification training module. The project classification training module performs a training operation according to a plurality of files of the projects and generates a determination logic to predict the relevance between the terms in the statement content and each keyword set. The terms include a first term and a second term appearing in the keyword sets. The project classification module generates a first determination result according to the relevance between the first term and each keyword set. The project classification module generates a second determination result according to the relevance between the second term and each keyword set. The project classification module generates a third determination result according to the determination logic. The project classification module classifies the meeting record to one of the projects according to the first determination result, the second determination result, the third determination result, and a weight ratio of the three determination results.

According to some embodiments, the work log posting system further includes a cost calculation module. The cost calculation module counts a cost of each project according to the meeting period attended by each person, a project to which the meeting period belongs, and an hourly wage of the person in the work log.

According to some embodiments, the work log posting system further includes a human-computer interface module. Each person adjusts and controls the work log through the human-computer interface module.

According to some embodiments, the meeting record analysis module receives the meeting record from a video device and analyzes the meeting record to extract the terms from the statement content of the meeting record, wherein the meeting record is a video file.

According to some embodiments, the meeting record analysis module receives the meeting record from a communication medium and analyzes the meeting record to extract the terms from the statement content of the meeting record, wherein the meeting record is a text file.

Therefore, according to some embodiments, a meeting record analysis module is configured to analyze a statement content, an attendance list, and a meeting period of a meeting record and extract a plurality of terms from the statement content. A project classification module compares the relevance between the terms extracted from the statement content and the keyword sets of the projects to determine the meeting record is attached to which project. A work log module counts the meeting period attended by each person, the project to which the meeting period belongs, and a statement content of the meeting period, so as to preload the statistical result into a work log. Therefore, employees or users do not have to spend time in filling in the work log, the problem of incomplete filling in the work log is alleviated, and the work efficiency of the employees or users is improved.

### BRIEF DESCRIPTION OF THE DRAWINGS

FIG. 1 is a schematic architectural diagram of an electronic device according to some embodiments;

FIG. 2 is a schematic block diagram of a work log posting system according to some embodiments;

FIG. 3 is a schematic block diagram of meeting record analysis according to some embodiments;

FIG. 4 is a schematic block diagram of the relevance between terms and keyword sets according to some embodiments; and

FIG. 5 is a schematic block diagram of a work log posting system according to some embodiments.

### DETAILED DESCRIPTION

A brief introduction is given to an appropriate computing environment that can be configured to implement the present invention before a work log posting technology of specific embodiments of the present invention is described. The technology of the embodiments of the present invention is applicable to a variety of general-purpose or special-purpose computing systems, environments or configurations, which are, for example, but not limited to, personal computers (PCs), server computers, handheld or laptop devices, multi-processor systems, microprocessor-based systems, set-top boxes, network PCs, mini-computers, host computers, etc.

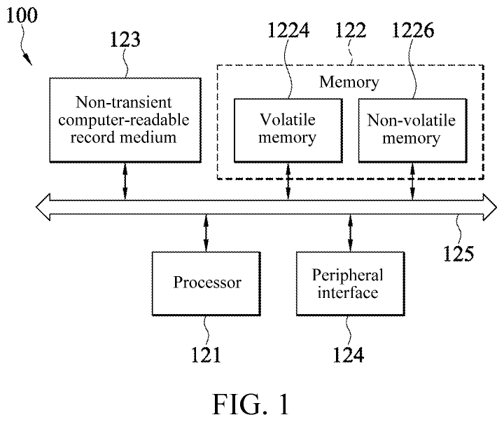

FIG. 1 illustrates an embodiment of an appropriate computing environment. Referring to FIG. 1, an exemplary environment for implementing the work log posting technology of the present invention is shown. FIG. 1 is a schematic architectural diagram of an electronic device 100 according to some embodiments. The electronic device 100 includes a processor 121, a memory 122, a non-transient computer-readable record medium 123, a peripheral interface 124, and a bus 125 for the elements to communicate with each other. The processor 121 is, for example, but not limited to, a central processing unit (CPU). The memory 122 includes, but not limited to, a volatile memory (e.g., a random access memory (RAM)) 1224 and a non-volatile memory (e.g., a read-only memory (ROM)) 1226. The non-transient computer-readable record medium 123 may be, for example, a hard disk or a solid state drive. The peripheral interface 124 may include, for example, an input/output interface, a graphical interface, and a communication interface (e.g., a network interface). The bus 125 includes, but not limited to, a combination of one or more of a system bus, a memory bus, a peripheral bus, etc.

The electronic device 100 may include one or more computing devices. In some embodiments, the technology of the present invention may also be implemented in a distributed computing environment. For example, the electronic device 100 may support cloud computing services for connection and access by other networked devices. The computing services include, but are not limited to, for example, infrastructure as a service, platform as a service, software as a service, storage as a service, desktop as a service, data as a service, security as a service, and application program interface (API) as a service.

After the introduction to the exemplary operating environment, computer-readable instructions such as program modules that may be executed in a computing device or a cloud computing service to specifically implement the work log posting technology of the present invention will be described in the rest of the specification. Herein, the program modules are, for example, but not limited to, routines, application programs, objects, elements, and data structures, which may perform specific work or implement specific abstract data types.

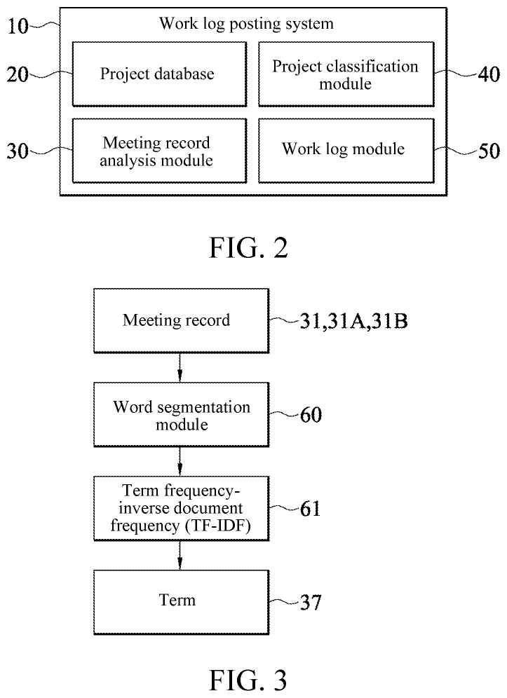

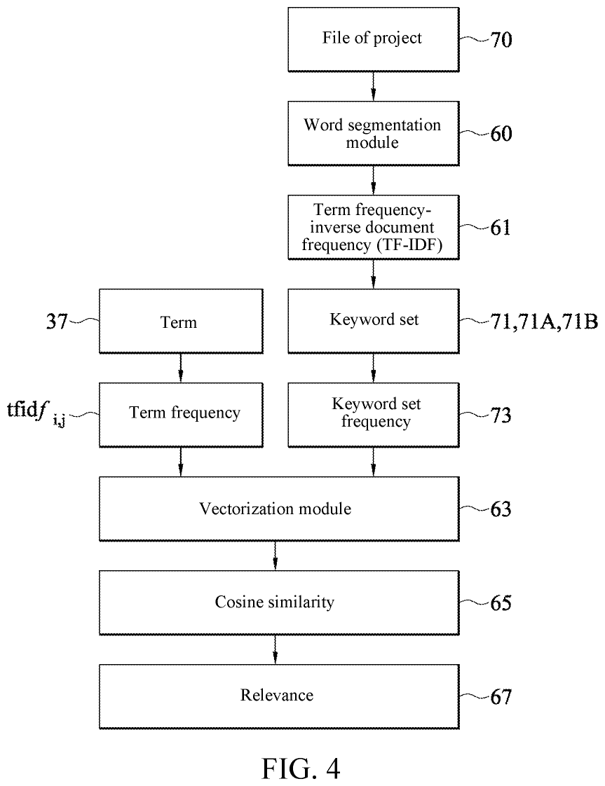

Referring to FIG. 2, FIG. 3, and FIG. 4. FIG. 2 is a schematic block diagram of a work log posting system 10 according to some embodiments. FIG. 3 is a schematic block diagram of meeting record analysis according to some embodiments. FIG. 4 is a schematic block diagram of the relevance 67 between terms 37 and keyword sets 71 according to some embodiments. The work log posting system 10 includes a project database 20, a meeting record analysis module 30, a project classification module 40, and a work log module 50. The project database 20 stores a plurality of keyword sets 71, each corresponding to a project. The meeting record analysis module 30 analyzes a meeting record 31 including a statement content, an attendance list, and a meeting period, to extract a plurality of terms 37 from the statement content of the meeting record 31. The project classification module 40 classifies the meeting record 31 to one of the projects according to the relevance 67 between the terms 37 in the statement content and each keyword set 71. The work log module 50 counts, according to the classification result of the meeting record 31, the meeting period attended by each person on the attendance list and the project to which the meeting period belongs, so as to preload the statistical result into a work log.

The work log posting system 10 is adapted to automatically preload a work log. The work log is, for example, but not limited to, work content, work time, project items of the work content, travel records, etc. of a user. In some embodiments, the work log posting system 10 can output the pre-loaded work log onto a display screen or into an electronic statistical report or a paper statistical report, etc.

The keyword set 71 is a cluster of keywords that are of high importance to a plurality of projects and that are extracted from a file 70 of the projects, such as a project proposal or a project report.

The meeting record 31 may be an electronic file, a paper file, a voice file, a video file, an image file, etc. The statement content is matters participated, spoke, and wrote by people on the attendance list at the meeting. The attendance list is a list of persons attending the meeting. The terms 37 are formed by a single word or a plurality of words.

In some embodiments, the project classification module 40 classifies the meeting record 31 to one of the projects according to the relevance 67 between the terms 37 in the statement content and each keyword set 71. For example, when the relevance 67 between the terms 37 and each keyword set 71 is higher, the project classification module 40 classifies the meeting record 31 to the project corresponding to the keyword set 71 with the high relevance 67.

In some embodiments, the relevance 67 between the terms 37 in the statement content and each keyword set 71 may be an absolute relevance or a relative relevance. For example, when the terms 37 in the statement content exactly match keywords in the keyword set 71, the relevance 67 is an absolute relevance. In this case, the project classification module 40 classifies the meeting record 31 corresponding to the statement content to the project corresponding to the keyword set 71. When the terms 37 in the statement content do not exactly match the keywords in the keyword set 71, the relevance 67 is a relative relevance. For example, a degree of matching between the terms 37 in the statement content and one keyword set 71 is up to 90% and a degree of matching between the terms 37 and another keyword set 71 is only 40%. In this case, the project classification module 40 classifies the meeting record 31 corresponding to the statement content to the project corresponding to the keyword set 71 with the degree of matching is 90%.

Referring to FIG. 3, in some embodiments, the meeting record analysis module 30 analyzes the meeting record 31 to calculate a term frequency tfidf_{i,j} of each sentence in the statement content, and extracts the terms 37 in the sentences from the statement content according to the term frequencies tfidf_{i,j}. For example, the meeting record analysis module 30 performs a word-segmentation operation on each sentence of the meeting record 31 through the word segmentation module 60 and generates a plurality of terms 37. The meeting record analysis module 30 calculates the importance of each term 37 to the meeting record 31 through an algorithm of term frequency-inverse document frequency (TF-IDF) 61 and respectively generates a term frequency tfidf_{i,j}. The meeting record analysis module 30 extracts the terms 37 with high term frequencies tfidf_{i,j} from the statement content. For example, The meeting record analysis module 30 extracts the terms 37 with the top three term frequencies tfidf_{i,j} from the statement content. Therefore, it can be known that the extracted terms 37 are relative importance to the meeting record 31.

A method for calculating the TF-IDF 61 may be as shown in Formula 1 below. tf_{i,j} is a term frequency, representing a frequency at which a term appears in a file, and tf_{i,j} may be expressed by Formula 2 below. idf_{i,j} is an inverse file frequency, representing a degree of general importance of a term, and idf_{i,j} may be expressed by Formula 3 below. n_{i,j} represents a quantity of appearance of a term i in a file j, wherein the term i represents for one type of the specific terms. Σₖ n_{k,j} represents totaling quantities of appearance of k types of the specific terms in the file j, D represents a total quantity of files in a file set or a corpus, and dfᵢ represents a quantity of files including the term i in the file set or the corpus.

$$\begin{matrix}{tfidf}_{i , j} = {tf}_{i , j} \times {idf}_{i , j} & ( Formula 1 ) \\ {tf}_{i , j} = \frac{{n}_{i , j}}{{\sum }_{k} {n}_{k , j}} & ( Formula 2 ) \\ {idf}_{i , j} = log \frac{D}{{df}_{i}} & ( Formula 3 )\end{matrix}$$

As shown in Formula 2, when a term appears in a file more frequently, the term is more important for the file. When tf_{i,j} is higher, for example, when a term 37 appears in a meeting record 31 more frequently, the term 37 is more important to the file 31.

As shown in Formula 3, when there are a smaller quantity of files including the term i in the file set or the corpus, the term i is more important for the file including the term i, and the value of idf_{i,j} is higher. Conversely, when multiple files include the term i, the term i has low importance, and the value of idf_{i,j} is lower. Therefore, a higher value of idf_{i,j} represents higher importance of the term i to a single file. For example, when the term 37 appears in each meeting record 31, the term 37 is less important for a single meeting record 31. Conversely, when the term 37 appears in only one meeting record 31 but not in other meeting records 31, the term 37 is more important for the meeting record 31 in which the term 37 appears. Therefore, a higher value of the term frequency tfidf_{i,j} represents higher importance of the term 37 to the meeting record 31, and the term 37 is regarded as a keyword of the meeting record 31.

The word segmentation module 60 is, for example, but not limited to, a jieba Chinese word segmentation suite. In some embodiments, the word segmentation module 60 may be disposed in the work log posting system 10, the meeting record analysis module 30, the project classification module 40, or an external device.

In some embodiments, the meeting record analysis module 30 analyzes the meeting record 31 and the plurality of keyword sets 71 to extract the terms 37 appearing in the keyword sets 71 from the statement content. For example, the meeting record analysis module 30 performs a work-segment on each sentence of the meeting record 31, and generates a plurality of the terms 37 through the word segmentation module 60. The meeting record analysis module 30 compares the terms 37 with the keyword sets 71 and picks up the terms 37 appearing in the keyword sets 71, so as to help the project classification module 40 calculate the relevance 67 between the terms 37 in the statement content and the keyword sets 71 (to be detailed later).

Referring to FIG. 4, in some embodiments, the project classification module 40 calculates the relevance according to a term frequency tfidf_{i,j} corresponding to each term 37 in the statement content and a keyword set frequency 73 corresponding to each keyword set 71 in each project. For example, a plurality of files 70 of a project are word-segmented by a word segmentation module 60 to generate a plurality of segmented words. Calculating the importance of each segmented word to the project through an algorithm of TF-IDF 61, extracting a plurality of keywords from the segmented words to form a keyword set 71, and storing the keyword set 71 in the project database 20. Each keyword in the keyword set 71 corresponds to a term frequency tfidf_{i,j} to form a keyword set frequency 73. The meeting record analysis module 30 analyzes the meeting record 31 and the plurality of keyword sets 71 to extract the terms 37 appearing in the keyword sets 71 from the statement content, and calculates term frequencies tfidf_{i,j} of the terms 37 in the meeting record 31 through the algorithm of TF-IDF 61. The project classification module 40 vectorizes the keyword set frequency 73 of each keyword set 71 and the term frequencies tfidf_{i,j} of the terms 37 by a vectorization module 63 to obtain feature vectors corresponding to each keyword set 71 and the terms 37, and calculates and obtains the relevance 67 between the terms 37 and each keyword set 71 according to an algorithm of cosine similarity 65.

The algorithm of cosine similarity 65 may be as shown by Formula 4 below. “A” represents a feature vector of the keyword set frequency 73 of the keyword set 71, “B” represents a feature vector of the term frequencies tfidf_{i,j} of the terms 37, Aᵢ represents a component of A, Bᵢ represents a component of B, and n represents a total quantity of components. The algorithm of cosine similarity 65 measures similarity of files corresponding to two vectors by calculating a cosine value cos θ of angles between the two vectors. The cosine value cos θ is between 1 and −1. If the cosine value cos θ is closer to 1, the similarity of the two files is higher. Conversely, if the cosine value cos θ is closer to −1, the similarity of the two files is lower. For example, when a cosine value cos θ for the feature vector of the keyword set frequency 73 of the keyword set 71 and the feature vector of the term frequencies tfidf_{i,j} of the terms 37 calculated according to the algorithm of cosine similarity 65 is closer to 1, the similarity between the keyword set 71 and the terms 37 is higher, that is, the relevance 67 is higher. Conversely, the closer the cosine value cos θ is to −1, the similarity between the keyword set 71 and the terms 37 is lower, that is, the relevance 67 is lower.

$$cos θ = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad ( Formula 4 )$$

The vectorization module 63 is, for example, but not limited to, a word to vector suite, a word embedding suite, or a suite for combining values into vectors. In some embodiments, the vectorization module 63 may be disposed in the work log posting system 10, the meeting record analysis module 30, the project classification module 40, or an external device.

In some embodiments, the project classification module 40 may calculate and obtain the relevance 67 according to an overlap rate between the terms 37 extracted from the statement content by the meeting record analysis module 30 and keywords in each keyword set 71. For example, the meeting record analysis module 30 extracts the terms with the top three term frequencies tfidf_{i,j} from the statement content, and the project classification module 40 classifies the meeting record 31 to one of the plurality of projects according to an overlap rate between the terms 37 and the keywords in each keyword set 71. For example, two of the three terms 37 extracted by the meeting record analysis module 30 from one of a plurality of meeting records 31A are identical to keywords in one of a plurality of keyword sets 71A, or three terms 37 extracted from another meeting record 31B are all identical to the keywords in the keyword set 71A. In this case, the project classification module 40 compares the quantity of the extracted terms 37 which are identical to the keywords in the keyword set 71A. When the quantity is greater, the relevance 67 between the terms 37 and the keyword set 71 is higher. For example, the relevance 67 between the terms 37 in the meeting record 31B and the keyword set 71A is higher than the relevance 67 between the terms 37 in the meeting record 31A and the keyword set 71A. The project classification module 40 classifies the meeting record 31 corresponding to the terms 37 to the project corresponding to the keyword set 71 with the high relevance 67. Herein, the overlap rate of the keywords may be calculated by dividing the quantity of the extracted terms 37 which are identical to the keywords in the keyword set 71 by a total quantity of the extracted terms 37 (unconditional carry may be adopted).

In another example, the meeting record analysis module 30 analyzes the meeting record 31 and each keyword set 71 to extract the terms 37 appearing in the keyword sets 71 from the statement content of the meeting record 31, wherein two of a plurality of terms 37 extracted from one of a plurality of meeting records 31A are identical to keywords in one of a plurality of keyword sets 71A, and five terms 37 are identical to keywords in another keyword set 71B. Five of a plurality of terms 37 extracted from another meeting record 31B are identical to the keywords in the keyword set 71A, and two terms 37 are identical to the keywords in another keyword set 71B. In this case, the project classification module 40 compares the quantity of the extracted terms 37 which are identical to the keywords in each keyword set 71. When the quantity is greater, the relevance 67 between the terms 37 and the keyword set 71 is higher. For example, the relevance 67 between the terms 37 in the meeting record 31B and the keyword set 71A is higher, and the relevance 67 between the terms 37 in another meeting record 31A and another keyword set 71B is higher.

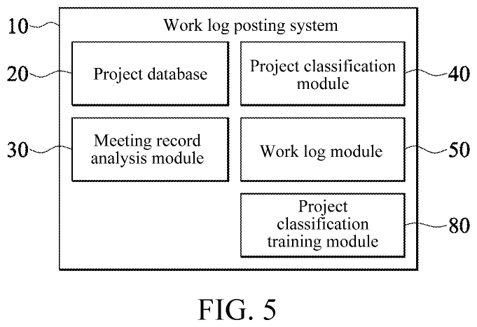

Referring to FIG. 5, FIG. 5 is a schematic block diagram of a work log posting system 10 according to some embodiments. In some embodiments, the work log posting system 10 further includes a project classification training module 80. The project classification training module 80 performs a training operation according to files 70 of a plurality of projects and generates a determination logic to predict the relevance 67 between the terms 37 in the statement content and each keyword set 71. The project classification module 40 classifies the meeting record 31 to one of the projects according to the determination logic. For example, the project classification module 40 first collects files 70 of the projects, for example, a project topic, a project profile, tasks in the projects, and a project report. The project classification module 40 performs a word-segmentation operation on the files 70 of the projects, extracts the term vector features of terms obtained by a vectorization module 63, and the term vector features are configured to a training file. The project classification training module 80 inputs the training file to a long short-term memory (LSTM) to obtain a plurality of determination logics through training. The determination logics may be configure to predict the relevance 67 between the terms 37 in the statement content and each keyword set 71. In this case, the project classification module 40 may obtain the relevance 67 between the terms 37 in the statement content and each keyword set 71 according to the determination logics and classify the meeting record 31 to the project corresponding to the keyword set 71 with the high the relevance 67.

Referring to FIG. 2 to FIG. 5, in some embodiments, the terms 37 include a first term and a second term appearing in the keyword set 71. The project classification module generates a first determination result according to the relevance 67 between the first term and each keyword set 71, generates a second determination result according to the relevance 67 between the second term and each keyword set 71, generates a third determination result according to the determination logic, and classifies the meeting record 31 to one of the projects according to the first determination result, the second determination result, the third determination result, and a weight ratio of the first determination result, the second determination, and the third determination result. For example, the meeting record analysis module 30 extracts the first term from the statement content according to the term frequencies tfidf_{i,j}, for example, the terms 37 with the top three term frequencies tfidf_{i,j}. The project classification module 40 generates a first determination result according to the relevance 67 between the first term and the keyword set 71. The meeting record analysis module 30 analyzes the meeting record 31 and the keyword set 71 to extract the second term appearing in the keyword set 71 from the statement content. For example, comparing the meeting record 31 with each keyword set 71, and extracting all the terms 37 appearing in the keyword sets 71 from the statement content of the meeting record 31. The project classification module 40 generates a second determination result according to the relevance 67 between the second term and the keyword set 71. The project classification module 40 generates a third determination result according to the determination logic. The project classification module 40 classifies the meeting record 31 to one of the projects according to the first determination result, the second determination result, the third determination result, and the weight ratio of the first determination result, the second determination, and the third determination result. For example, the third determination result is assigned a third weight ratio α, the first determination result is assigned a first weight ratio β, the second determination result is assigned a second weight ratio 1-α-β, and a sum of the first weight ratio, the second weight ratio, and the third weight ratio is 1. Accuracy of classification can be improved by assigning different weight ratios to the plurality of determination results to classify the meeting record 31 to a project. Herein, since the extraction of the first term, the extraction of the second term, the determination logic, the relevance 67 between the first term and the keyword set 71, the relevance 67 between the second term and the keyword set 71, and the determination of the relevance 67 according to the determination logic have been described above, descriptions thereof are omitted herein.

In some embodiments, when there are a smaller quantity of files 70 of the projects for training by the project classification training module 80, accuracy of the classification of the meeting record 31 to the corresponding project can be improved by reducing the third weight ratio α. For example, the value of the third weight ratio α is set to be less than or equal to 0.4.

In some embodiments, the work log posting system 10 further includes a cost calculation module. The cost calculation module counts a cost of each project according to the meeting period attended by each person, the project to which the meeting period belongs, and an hourly wage of each person. For example, the cost calculation module calculates an amount by multiplying the meeting period of each person by an hourly wage corresponding to each person, and counts the amount and the meeting period corresponding to the project to obtain a cost of the project. In some embodiments, the cost calculation module outputs the cost of the project to a display screen or into an electronic report or a paper report, etc.

In some embodiments, the meeting record analysis module 30, the project classification module 40, the work log module 50, and the cost calculation module may be integrated into a single module.

In some embodiments, the work log posting system 10 further includes a human-computer interface module. Each person may adjust and control the work log through the human-computer interface module. For example, each person may input an operation through the human-computer interface module and adjust and view content of the work log to make the work log better. A human-computer interface may include buttons, knobs, a touch screen, etc. The present invention is not limited thereto, and in some embodiments, the human-computer interface is constructed in mobile phones, computers, laptop computers, tablet computers, etc.

In some embodiments, the meeting record analysis module 30 receives the meeting record 31 from a video device and analyzes the meeting record 31 to extract the terms 37 from the statement content of the meeting record 31, wherein the meeting record 31 is a video file. For example, the video device records a meeting into a video file (or a voice file). The meeting record analysis module 30 converts the meeting record 31 of the video file (or the voice file) into a text file through a suite for converting a video into text. The text file includes names of people who attends to the meeting (i.e., an attendance list), a statement content, and meeting duration (i.e., a meeting period). The meeting record analysis module 30 analyzes the meeting record 31 converted into the text file to extract terms 37 from the statement content of the meeting record 31. Herein, since the manner in which the meeting record analysis module 30 analyzes the meeting record 31 and extracts the terms 37 has been described above, descriptions thereof are omitted herein.

In some embodiments, the meeting record analysis module 30 receives the meeting record 31 from a communication medium and analyzes the meeting record 31 to extract the terms 37 from the statement content of the meeting record 31, wherein the meeting record 31 is a text file. For example, a communication medium (such as Line, Facebook, or Skype) outputs content (i.e., a meeting record 31) in a chat room as a text file. The text file includes speakers (i.e., an attendance list) in the chat room, a statement content of the speakers, and a statement time of the speakers. The meeting record analysis module 30 receives the text file from the communication medium and analyzes the text file to extract terms 37 from the statement content of the text file (i.e., the meeting record 31). Herein, the statement time of each speaker is counted as a meeting period. Herein, since the manner in which the meeting record analysis module 30 analyzes the meeting record 31 and extracts the terms 37 has been described above, descriptions thereof are omitted herein.

Therefore, according to some embodiments, a meeting record analysis module is configured to analyze a statement content, an attendance list, and a meeting period of a meeting record and extract a plurality of terms from the statement content. A project classification module compares the relevance between the terms extracted from the statement content and the keyword sets of the projects to determine the meeting record is attached to which project. A work log module counts the meeting period attended by each person, the project to which the meeting period belongs, and a statement content of the meeting period, so as to preload the statistical result into a work log. Therefore, employees or users do not need to spend time in filling in the work log, the problem of incomplete filling in the work log is alleviated, and the work efficiency of the employees or users is improved.

What is claimed is:

1. A work log posting system, comprising:
a project database, storing a plurality of keyword sets, each corresponding to a project;
a meeting record analysis module, analyzing a meeting record that comprises a statement content, an attendance list, and a meeting period, to extract a plurality of terms from the statement content;
a project classification module, classifying the meeting record to one of the projects according to the relevance between the terms in the statement content and each keyword set; and
a work log module, counting, according to the classification result of the meeting record, the meeting period attended by each person on the attendance list and a project to which the meeting period belongs, so as to preload the statistical result into a work log.

2. The work log posting system according to claim 1, wherein the meeting record analysis module analyzes the meeting record to calculate a term frequency of each sentence in the statement content, and extracts the terms in the sentences from the statement content according to the term frequencies.

3. The work log posting system according to claim 1, wherein the meeting record analysis module analyzes the meeting record and the keyword sets to extract the terms appearing in the keyword sets from the statement content.

4. The work log posting system according to claim 1, wherein the project classification module calculates the relevance according to a term frequency corresponding to each term in the statement content and a keyword set frequency corresponding to each keyword set in each project.

5. The work log posting system according to claim 1, further comprising a project classification training module, performing a training operation according to a plurality of files of the projects, and generating a determination logic to predict the relevance between the terms in the statement content and each keyword set, wherein the project classification module classifies the meeting record to one of the projects according to the determination logic.

6. The work log posting system according to claim 1, further comprising a project classification training module, performing a training operation according to a plurality of files of the projects, and generating a determination logic to predict the relevance between the terms in the statement content and each keyword set, wherein
the terms comprise a first term and a second term appearing in the keyword sets, the project classification module generates a first determination result according to the relevance between the first term and each keyword set, generates a second determination result according to the relevance between the second term and each keyword set, generates a third determination result according to the judgment logic, and classifies the meeting record to one of the projects according to the first determination result, the second determination result, the third determination result, and a weight ratio of the first determination result, the second determination, and the third determination result.

7. The work log posting system according to claim 1, further comprising a cost calculation module, counting a cost of each project according to the meeting period attended by each person, a project to which the meeting period belongs, and an hourly wage of the person in the work log.

8. The work log posting system according to claim 1, further comprising a human-computer interface module, wherein each person adjusts and controls the work log through the human-computer interface module.

9. The work log posting system according to claim 1, wherein the meeting record analysis module receives the meeting record from a video device and analyzes the meeting record to extract the terms from the statement content of the meeting record, wherein the meeting record is a video file.

10. The work log posting system according to claim 1, wherein the meeting record analysis module receives the meeting record from a communication medium and analyzes the meeting record to extract the terms from the statement content of the meeting record, wherein the meeting record is a text file.
